(19) United States
(12) Patent Application Publication
(10) Pub. No.: US 2025/0085712 A1
(43) Pub. Date: Mar. 13, 2025

(54) AUTONOMOUSLY DRIVING VEHICLE FOR TRAVELING ON AN UNPAVED TERRAIN SECTION, COMPUTER-IMPLEMENTED CONTROL METHOD FOR CONTROLLING AN AUTONOMOUSLY DRIVING VEHICLE, AND COMPUTER PROGRAM PRODUCT

(71) Applicant: Continental Automotive Technologies GmbH, Hannover (DE)

(72) Inventors: Oliver Horeth, Regensburg (DE); Thiemo Buchner, Saal a.d.Donau (DE); Antonio Weber, Regensburg (DE)

(73) Assignee: Continental Automotive Technologies GmbH, Hannover (DE)

(21) Appl. No.: 18/294,385

(22) PCT Filed: Jul. 14, 2022
(86) PCT No.: PCT/DE2022/200159

§ 371 Date: Feb. 1, 2024

(30) Foreign Application Priority Data
Aug. 2, 2021 (DE) 10 2021 208 343.9

(51) Int. Cl. G05D 1/617; G05D 107/30

(52) U.S. Cl. CPC G05D 1/617; G05D 2107/30

(57) ABSTRACT

The disclosure relates to an autonomously driving vehicle for traveling on an unpaved terrain section, comprising an assessment device and a control device, wherein the assessment device has a soil condition determination device for determining a condition parameter which is representative of the current soil condition of the terrain section, a storage device for storing a drivability dependence of acquired historic slipping data of the vehicle on the condition parameter, and an evaluation device, which determines a discrete drivability prediction of the terrain section by the vehicle based on the drivability dependence and the determined condition parameter. The control device is designed to control the vehicle based on the drivability prediction to drive on the terrain section. Furthermore, the disclosure relates to a computer-implemented control method for controlling the autonomously driving vehicle and a computer program product.

### CROSS-REFERENCE TO RELATED APPLICATIONS

The present application is a National Stage Application under 35 U.S.C. § 371 of International Patent Application No. PCT/DE2022/200159 filed on Jul. 14, 2022, and claims priority from German Patent Application No. 10 2021 208 343.9 filed on Aug. 2, 2021, in the German Patent and Trademark Office, the disclosures of which are herein incorporated by reference in their entireties.

### TECHNICAL FIELD

The disclosure relates to an autonomously driving vehicle for traveling on an unpaved terrain section, a computer-implemented control method for controlling an autonomously driving vehicle, and a corresponding computer program product.

### BACKGROUND

Using autonomously driving vehicles such as agricultural robots, for example, in order to dispense seed or to weed in unpaved terrain sections, for example, in fields, is already known in particular from agriculture. Corresponding applications of autonomously driving vehicles in such unpaved terrain sections are also conceivable for forestry types of use, in which these vehicles navigate in terrain sections which are subjected to weathering and are not paved.

Before these autonomously driving vehicles drive into the corresponding terrain section, however, it has to be assessed whether there is sufficient drivability of the terrain section so that, for example, it is possible to prevent the vehicle from sticking on, for example, a slippery underlying surface. Presently, the assessment with respect to the drivability of a terrain section is almost exclusively the responsibility of the vehicle driver and their experience. In agriculture, using shovel samples and complex technical systems to carry out the measurement of moisture and other soil characteristic values is additionally known. Most of these systems are based on taking soil samples.

On the one hand, there is the problem that such systems for soil sample analysis are relatively expensive, on the other hand, it may also only be assessed with difficulty therewith to what extent the soil condition has an effect on the drivability by various vehicle types.

The object of the disclosure is therefore to propose an autonomously driving vehicle which may make a prediction in a substantially automated manner as to whether an unpaved terrain section is drivable or not.

### SUMMARY

This object is achieved by an autonomously driving vehicle having the combination of features in the claims.

A computer-implemented control method for controlling an autonomously driving vehicle and a corresponding computer program product are the subject matter of the claims.

Embodiments of the disclosure are the subject matter of the claims.

An autonomously driving vehicle for traveling on an unpaved terrain section has a communication device, which is designed to communicate with an assessment device for assessing a drivability of the terrain section by the vehicle and with a control device for autonomously controlling the vehicle on the terrain section. The assessment device has a soil condition determination device for determining at least one condition parameter which is representative of the current soil condition of the terrain section, and a storage device in which a drivability dependence of acquired historical slipping data of the vehicle on the soil condition parameter is stored. Furthermore, the assessment device has an evaluation device, which determines a discrete drivability prediction of the terrain section by the vehicle based on the drivability dependence and the determined soil condition parameter. The control device is designed here to control the vehicle based on the drivability prediction to drive on the terrain section.

“Terrain section” is to be understood here as all types of terrain which are subjected to weathering and do not have paving, such as an asphalt layer. These can include, inter alia, agricultural and/or forestry terrain sections.

“Current” is to be understood as a time span shortly before or immediately before the use or the traveling of the autonomously driving vehicle in the terrain section. This may be understood, for example, as a period of time of a few minutes to approximately half an hour before the actual usage point of the vehicle in the terrain section.

In this context, “historic” data are to be understood as data which have been acquired or determined or stored before this “current” time span. These historic data may have been determined, for example, by learning journeys, however, it is also possible that these historic data, for example, the slipping data of the vehicle, have been generated by a simulation.

The slipping data of the vehicle may be represented here by traction values of the vehicle and/or torque values of tires fastened on the vehicle and/or acceleration values of the vehicle. On the one hand, they have a dependence on the soil condition of the unpaved terrain section, however, on the other hand they also have a dependence on individual vehicle properties such as a type of the tires, an air pressure in the tires, and/or a tool fastened on the vehicle, such as a hoe or further sensor devices such as cameras.

On the basis of historic slipping data and the soil condition of the terrain section prevailing at the point in time of the acquisition of the historic slipping data, it is known how well the vehicle could move on the terrain section so that a drivability prediction of the terrain section by the vehicle may be made on the basis of experience if the current soil condition of the terrain section is known. This knowledge is obtained by determining at least one condition parameter. Multiple parameters come into consideration as the condition parameter which represents the current soil condition of the terrain section, such as the underlying material (sand, turf, gravel, . . . ), the degree of watering of the terrain section (muddy, wet, dry, . . . ), weather data (rain, sun, outside temperature, . . . ), data on the topography or the soil profile, etc.

The at least one condition parameter may be acquired here, for example, by external devices such as drones or satellites and transmitted, for example, via a backend to the vehicle. It is also possible to use the data of weather services or ground profile maps and topography maps as further information sources. It is also conceivable that the at least one condition parameter is assessed by technical personnel and updated in a system which transmits the condition parameter to the vehicle.

Based on the historic slipping data of the vehicle, which were present with a specific condition parameter, and the determined at least one condition parameter, it is possible for the evaluation device to make a discrete drivability prediction about the extent to which the vehicle can travel on the terrain section. Discrete is to be understood here as a step-by-step drivability prediction, i.e., the evaluation device decides whether the terrain section is not drivable, is poorly drivable, is partially drivable, or is even unrestrictedly drivable for the vehicle in question.

The autonomously driving vehicle is therefore capable of predicting how well the terrain section is drivable and, based on the assessment of the drivability of the terrain section, may make a qualitative decision whether and under which conditions the terrain section may be traveled.

It is thus possible to decide whether a specific vehicle having very special vehicle properties or a robot will be used in the currently prevailing environmental conditions—represented by the condition parameter of the terrain section—in a defined terrain section and how high the risk is that a failure of the vehicle and accompanying high repair costs could occur in this case. In addition to the risk assessment, it is also possible to optimize the use of autonomous vehicles or robots, for example, with respect to number and/or area of use in agriculture by means of the determined drivability prediction.

The autonomously driving vehicle preferably has a slip detection device for detecting current slipping data of the vehicle when driving on the terrain section, wherein the storage device is designed for storing the currently required slipping data together with the determined current condition parameter.

The storage device has a machine learning device, which is designed for machine learning of an updated drivability dependence on the detected current slipping data of the vehicle on the condition parameter.

The vehicle therefore instantaneously detects the current slipping data as it drives over the terrain section and relates them to the acquired current condition parameter. It is thus possible to train the machine learning device so that the evaluation device may make a drivability prediction which comes close to or in the best case completely corresponds to the actual drivability.

The evaluation device uses the most up-to-date data here, i.e., when the machine learning device stores an updated drivability dependence in the storage device, the evaluation device uses it to be able to make a more accurate drivability prediction.

Via the use of the machine learning device, it is possible that the autonomously driving vehicle successively approximates the limits of a drivability of a terrain section. It is then possible that the vehicle in spite of the drivability prediction made “poorly drivable” travels on the terrain section and acquires slipping data in this case via the slip detection device which indicate that the drivability prediction—for example if the vehicle gets stuck—would have to change to “not drivable” or—for example if the journey runs without problems—the drivability prediction is changed to “unrestrictedly drivable”. It is possible by way of the learning process to be able to make gradually more accurate drivability predictions for the specific observed vehicle.

The historic data which are used as a reference from other journeys in this special terrain section, are combined here with data from instantaneous measurements of the vehicle as it drives through the terrain section.

The soil condition determination device is designed for determining the current soil condition parameter with a GNSS position accuracy of less than 5 m, in particular less than 3 m, more particularly less than 1 m, preferably 1 cm to 5 cm, and preferably for receiving a current soil condition parameter determined outside the autonomously driving vehicle.

The slip detection device is designed for acquiring the slipping data with a GNSS position accuracy of less than 5 m, in particular less than 3 m, more particularly less than 1 m, preferably 1 cm to 5 cm.

The accuracy of the prediction may be designated as essentially “position-faithful” with a distance deviation of less than 5 m, in particular less than 3 m, more particularly less than 1 m, preferably 1 cm to 5 cm. It is advantageous if the determination of the soil condition is not carried out by the vehicle itself, wherein this is possible, however, but rather if the soil condition determination device is not part of the vehicle itself, but is arranged outside the vehicle. Accordingly, the current soil condition parameter is then externally transmitted to the vehicle, for example, from other vehicles which have previously traveled the terrain section, or via a common backend, for example, which collects data from a large number of vehicles. It is also possible to use further information sources here such as the data of weather services or ground profile maps and topographical maps, which were prepared, for example, via drones or satellites.

These data and characteristic values or at least a subset thereof may also be used to train the machine learning device. In particular in a training phase taking place before the first use of the vehicle, for example, it is also possible to have the actual drivability determined objectively via the assessment of technical personnel or traction values, so that the training may take place in a monitored manner. It may be conceivable here, for example, that an expert for determining the at least one condition parameter updates corresponding data in a system, which the vehicle uses.

In longer-term operation, it is even possible to check generally available data sources such as weather services for their interpretability with respect to the drivability predictions to be made by the evaluation device in the case of a specific vehicle on a defined terrain section. It may thus be determined more accurately to what extent generally available data sources may be made concretely usable.

A quantitative and qualitative assessment of present soil condition of a specific terrain section with respect to the drivability by a special vehicle may be determined by the acquisition of slipping data and condition parameters, which is position-faithful by means of GNSS, but also machine values of the observed vehicle itself (e.g., slip variables such as torque, accelerations, weight, tools such as hoe or camera, tires, air pressure, . . . ).

For example, it is also possible by way of the external soil condition determination device that the vehicle can use an empirical human assessment.

Overall, experiential values are thus compiled which represent the slip situation in specific conditions. The current situation is acquired via the soil condition determination device, i.e., which conditions are present, so that conclusions may be drawn about what would be the correct decision from experience: travel on the terrain section or not.

For this purpose, the control device has a decision device, which is designed to decide on the basis of the discrete drivability prediction whether and/or where the autonomously driving vehicle is to travel on the unpaved terrain section.

The decision device can be, for example, a higher-order system here, which can also be arranged outside the vehicle, and which is provided to prevent an autonomously driving vehicle, such as an agricultural robot, from being sent into a terrain section and risking an inability to maneuver in the terrain section.

A computer-implemented control method for controlling an autonomously driving vehicle has the following steps of determining at least one condition parameter which is representative of the current soil condition of the terrain section, determining a discrete drivability prediction of the terrain section by the vehicle based on the determined condition parameter and a drivability dependence of acquired historical slipping data of the vehicle on the condition parameter, and controlling the autonomously driving vehicle based on the drivability prediction.

For example, it is decided based on the discrete drivability prediction whether and/or where the autonomously driving vehicle is to travel on the unpaved terrain section.

The goal of the method is to generate a model which is capable of making a forecast which supplies a discrete prediction of the drivability of the terrain section, i.e., steps of the drivability such as “not drivable”, “poorly drivable”, “partially drivable”, “unrestrictedly drivable”.

It is thus possible to avoid problems during the autonomous operation of vehicles, in particular of, for example, agricultural robots, in that now an assessment of the drivability of the terrain section under discussion may be carried out beforehand, which was previously only possible during operation or in a punctiform manner. It is thus possible to minimize the risk of inability to maneuver or the risk of a loss of control of the autonomously driving vehicle or agricultural robot in field operation due to slippery terrain.

Current slipping data of the vehicle are acquired when driving on the terrain section and an updated drivability dependence on the acquired current slipping data of the vehicle to the condition parameter is trained based thereon. Since the method thus builds on machine learning, it may be adapted without a large amount of additional expenditure to various vehicle types and different terrain sections.

On the basis of machine learning, it is accordingly also possible to carry out weighting of different information sources such as weather services.

In the long term, the method may replace the assessment of a human vehicle driver and thus save costs and enable the autonomous operation of, for example, agricultural robots.

The applicability extends here to the drivability of all types of terrain sections by all types of vehicles or robots, in which an assessment of the soil condition is necessary because of environment, weather, or topography to avoid an inability to maneuver.

A computer program product has instructions which prompt a processor to carry out the above-described control method when the computer program product is executed by the processor.

### BRIEF DESCRIPTION OF THE DRAWINGS

Embodiments of the disclosure will be explained in more detail below with reference to the appended drawings, in which:

FIG. 1 shows a schematic view of two autonomously driving vehicles in different embodiments, which move on unpaved terrain sections;

FIG. 2 shows a schematic block diagram which represents a control system for controlling the autonomously driving vehicle from FIG. 1;

FIG. 3 shows a schematic flow chart to illustrate a control method for controlling the autonomously driving vehicles from FIG. 1;

FIG. 4 shows a schematic flow chart which represents further steps of the control method from FIG. 3; and

FIG. 5 shows examples of how the control method may be carried out in reality, wherein FIG. 5 a) represents the general method and FIG. 5 b) represents a specific example.

### DETAILED DESCRIPTION

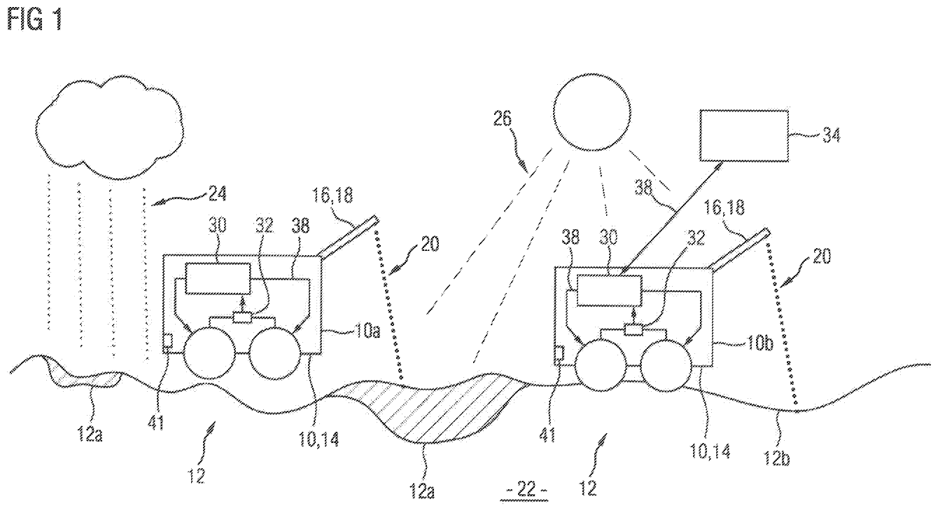

FIG. 1 shows a schematic view of two autonomously driving vehicles 10 in two different embodiments, which each move on unpaved terrain sections 12. In the embodiments shown in FIG. 1, the autonomously driving vehicles 10 are designed as agricultural robots 14, each of which has a sowing arm 18, using which seeds 20 are dispensed, as a tool 16. Both agricultural robots 14 move on an agriculturally cultivated field 22 in different terrain sections 12, which are completely subjected to environmentally-related weathering conditions. As can be seen in FIG. 1, the field 22 has terrain sections 12a, which are wet or at least slippery due to rain 24, which has recently fallen thereon or is about to fall thereon, however, terrain sections 12b are also present, which have a hard topsoil in particular due to solar irradiation 26.

Both vehicles 10 are designed to decide either independently (first embodiment of the vehicle 10a on the left side) or within a common control system 28 (second embodiment of the vehicle 10b on the right side) whether and where the field 22 is autonomously drivable without an inability to maneuver of the agricultural robots 14 being able to occur.

For this purpose, both agricultural robots 14 have a control device 30, which controls the agricultural robots 14 to drive on the respective terrain sections 12 based on a discrete drivability prediction.

Both vehicles 10 additionally each have a slip detection device 32, via which current slipping data of the vehicles 10 are detected during their journey on the terrain section 12.

The vehicle 10b in the right embodiment communicates with a backend 34, in which parts of the control system 28 are outsourced, while all parts of the control system 28 are completely arranged in the vehicle 10a according to the first embodiment on the left side.

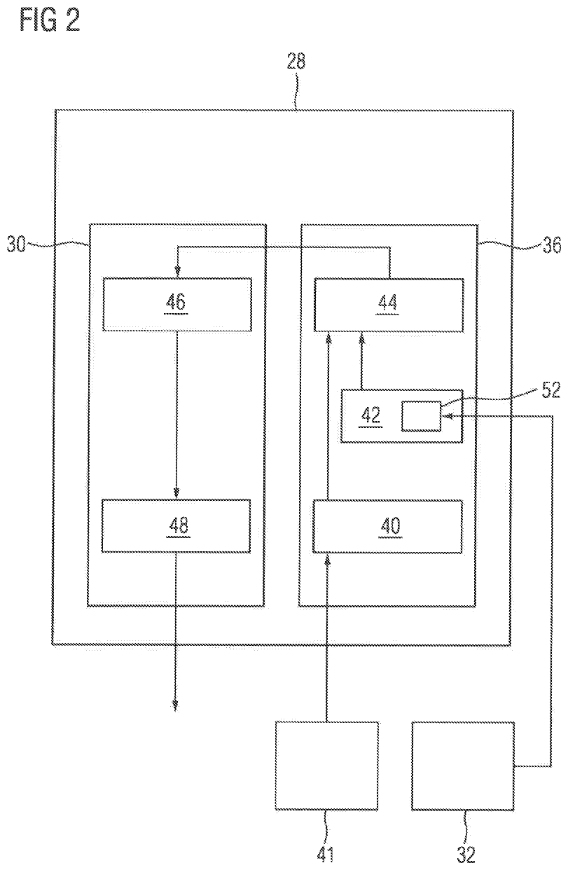

FIG. 2 shows a schematic block diagram of the control system 28, using which the two vehicles 10 are controlled before and during their journey on the respective terrain sections 12. As already mentioned with reference to FIG. 1 and the two exemplary embodiments shown, it is possible to arrange the parts of the control system 28 completely in the backend 34, however, it is also possible in all variations to house the parts of the control system 28 individually or completely in the vehicles 10.

The control system 28 has, on the one hand, the control device 30 and, on the other hand, an assessment device 36. The assessment device is designed to assess a drivability of the terrain sections 12 and to pass on this assessment to the control device 30, so that it may autonomously control each of the vehicles 10.

Both vehicles 10 from FIG. 1 have a communication device 38 in each case, via which the vehicles 10 may each communicate with the assessment device 36 or with the control device 30.

The assessment device 36 has a soil condition determination device 40, using which at least one condition parameter can be determined, which is representative of the current soil condition of the observed terrain section 12. This soil condition determination device may be, for example, a sensor 41 directly on the vehicles 10, however, it is also possible to determine the at least one condition parameter externally via, for example, satellites or drones or to use further information sources such as weather services or map services for ground profile maps or topographical maps.

The assessment device 36 furthermore has a storage device 42, in which drivability dependencies are stored. In the drivability dependencies, historical slipping data of the vehicles 10 are set as a function of condition parameters of the terrain sections 12, which prevailed during the acquisition of the historical slipping data.

Furthermore, the assessment device 36 has an evaluation device 44, which, based on the drivability dependency stored in the storage device 42 and the determined condition parameter, determines a discrete drivability prediction of the terrain section 12 by the vehicle 10. The corresponding data are accordingly transmitted to the evaluation device 44 from the soil condition determination device 40 and the storage device 42, so that it may process these data and make a discrete drivability prediction. Discrete is to be understood to mean step-by-step drivability predictions, such as “not drivable”, “poorly drivable”, “partially drivable”, “unrestrictedly drivable”.

The drivability prediction is transmitted by the evaluation device 44 to the control device 30, wherein the control device 30 has a decision device 46, which ultimately decides based on the drivability prediction of the evaluation device 44 whether the relevant vehicle 10 is to travel on the unpaved terrain section 12 in question, and in particular where. After this decision, which is transmitted to a signal output device 48, the control of the respective vehicle 10 on the respective terrain section 12 takes place via the signal output device 48.

In the example shown in FIG. 2, the vehicles 10 each have the slip detection device 32, which acquires current slipping data of the respective vehicle 10 when the vehicle 10 moves on the respective unpaved terrain section 12. These current slipping data are then transmitted to the storage device 42, where they are stored and then made available to the evaluation device 44.

In order to optimize the decision-making for each vehicle 10, the storage device 42 has a machine learning device 52, which may learn an updated drivability dependence based on the currently acquired slipping data together with the current condition parameter present during the journey. Because current data both with respect to the condition parameter and the current slipping data are fed again and again into the machine learning device 52, it is possible to train the evaluation device 36 as a whole to be able to make a better and better and more correct drivability prediction for the respective vehicle 10 and the respective terrain section 12.

In order that the processed data are as accurate as possible, both the slip detection device 32 and the soil condition determination device 40 are designed to each acquire their data in a position-faithful manner, i.e., with a GNSS position accuracy of, for example, less than 5 m, in particular less than 3 m, more particularly less than 1 m, preferably 1 cm to 5 cm.

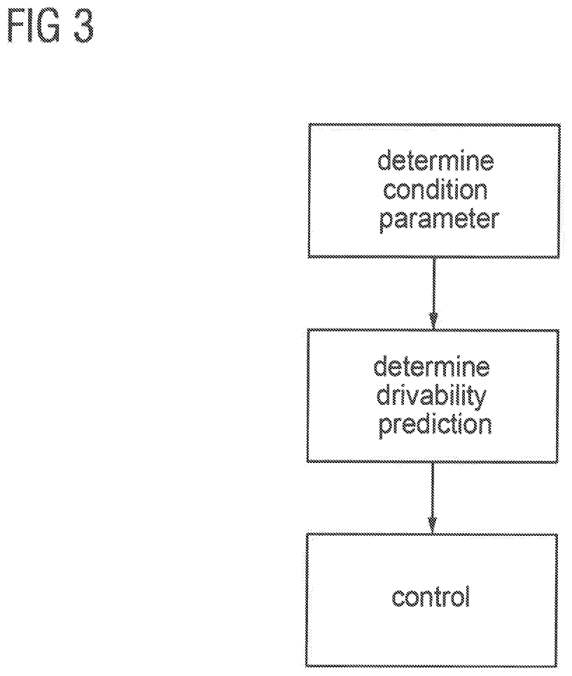

FIG. 3 shows a schematic flow chart which illustrates steps of a control method for controlling the autonomously driving vehicles 10 shown in FIG. 1.

In a first step, at least one condition parameter is determined, which is representative of a current soil condition of an unpaved terrain section 12 to be traveled on.

In a next step, a discrete drivability prediction is then determined which indicates how well the vehicle 10 can be expected to travel on the terrain section 12.

In a last step, the vehicle 10 is controlled based on this drivability prediction to drive on the terrain section 12.

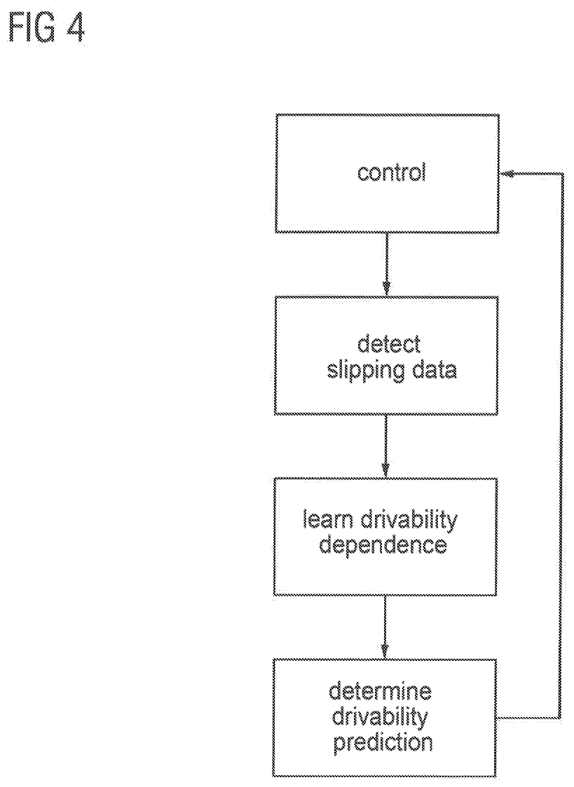

FIG. 4 shows a schematic flow chart having further steps of the control method from FIG. 3.

During the control of the respective vehicle 10 during the journey on the unpaved terrain section 12, slipping data specific for the vehicle 10 are acquired in a current and position-faithful manner. The assessment device 36 learns updated drivability dependencies based on these acquired slipping data and the currently determined condition parameter. These newly learned drivability dependencies are then made available again to be able to determine the discrete drivability prediction, whereupon the respective vehicle 10 can in turn be controlled in an optimized manner.

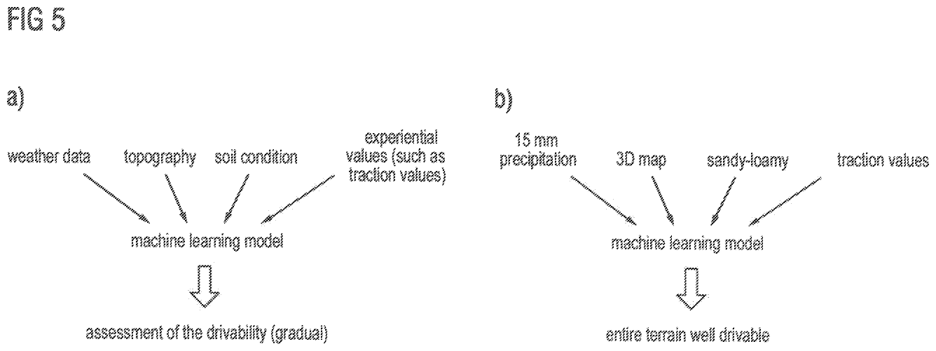

FIG. 5 shows by way of example which different data may be processed during the described control method in reality in order to make the respective drivability prediction.

In FIG. 5 a), an example of a general method is indicated here in which general weather data, topography data, soil condition data, and additional experiential values such as historic traction values are combined and made available to the machine learning device so that a machine learning model may be prepared, on the basis of which a gradual assessment of the drivability may take place.

FIG. 5 b) shows a more specific example in which a situation is present in which it rains with 15 mm precipitation, a 3D map of the terrain section 12 to be traveled on is available, it is known that the terrain section 12 is of a sandy-loamy condition, and in which the traction values of the driving vehicle 10 are known. These concrete data are also made available to the machine learning device, in order to prepare a machine learning model therefrom, on the basis of which it may be assessed that in the present case the observed terrain section 12 or even the entire field 22 from FIG. 1 is well drivable.

1. An autonomously driving vehicle for traveling on an unpaved terrain section, comprising a communication device for communicating with an assessment device for assessing a drivability of the terrain section by the vehicle and for communicating with a control device for autonomously controlling the vehicle on the terrain section, wherein the assessment device comprises:
a soil condition determination device for determining at least one condition parameter, which is representative of a current soil condition of the terrain section;
a storage device, in which a drivability dependence of acquired historical slipping data of the vehicle on the condition parameter is stored; and
an evaluation device which, based on the drivability dependence and the determined condition parameter, determines a discrete drivability prediction of the terrain section by the vehicle;
wherein the control device is designed to control the vehicle based on the drivability prediction to drive on the terrain section.

2. The autonomously driving vehicle as claimed in claim 1, further comprising a slip detection device for detecting current slipping data of the vehicle when driving on the terrain section, wherein the storage device is designed to store the acquired current slipping data together with the determined current condition parameter.

3. The autonomously driving vehicle as claimed in claim 2, wherein the storage device has a machine learning device, which is designed for machine learning of an updated drivability dependence of the acquired current slipping data of the vehicle on the condition parameter.

4. The autonomously driving vehicle as claimed in claim 1, wherein the soil condition determination device is designed to determine the current condition parameter with a GNSS position accuracy of less than 5 m, and to receive a current condition parameter determined outside the autonomously driving vehicle.

5. The autonomously driving vehicle as claimed in claim 2, wherein the slip detection device is designed to acquire the slipping data with a GNSS position accuracy of less than 5 m.

6. The autonomously driving vehicle as claimed in claim 1, wherein the control device has a decision device which is designed to decide on the basis of the discrete drivability prediction whether and/or where the autonomously driving vehicle is to travel on the unpaved terrain section.

7. A computer-implemented control method for controlling an autonomously driving vehicle, the computer-implemented control method comprising:
determining at least one condition parameter, which is representative of the current soil condition of a terrain section;
determining a discrete drivability prediction of the terrain section by the vehicle based on the determined condition parameter and a drivability dependence of acquired historic slipping data of the vehicle on the condition parameter; and
controlling the autonomously driving vehicle based on the drivability prediction.

8. The computer-implemented control method as claimed in claim 7, wherein it is decided based on the discrete drivability prediction whether and/or where the autonomously driving vehicle is to travel on the unpaved terrain section.

9. The computer-implemented control method as claimed in claim 7, wherein the current slipping data of the vehicle is detected when driving on the terrain section and, based thereon, an updated drivability dependence of the acquired current slipping data of the vehicle on the condition parameter is learned.

10. A computer program product comprising instructions which prompt a processor to carry out a method when the computer program product is executed by the processor, the method comprising:
determining at least one condition parameter, which is representative of a current soil condition of a terrain section;
determining a discrete drivability prediction of the terrain section by the vehicle based on the determined condition parameter and a drivability dependence of acquired historic slipping data of the vehicle on the condition parameter; and
controlling the autonomously driving vehicle based on the drivability prediction.
